(19) United States
(12) Patent Application Publication
(10) Pub. No.: US 2014/0181224 A1
(43) Pub. Date: Jun. 26, 2014

(54) CAPABILITY-BASED COMMUNICATIONS

(71) Applicants: Glenn R. Bruns, Naperville, IL (US); Vladimir Kolesnikov, Jersey City, NJ (US)

(72) Inventors: Glenn R. Bruns, Naperville, IL (US); Vladimir Kolesnikov, Jersey City, NJ (US)

(21) Appl. No.: 13/726,768

(22) Filed: Dec. 26, 2012

(51) Int. Cl. H04L 12/58

(52) U.S. Cl. CPC H04L 51/12
USPC 709/206

(57) ABSTRACT

A capability-based communication mechanism is provided for controlling delivery of messages. A capability-based address is an address having one or more capability parameters associated therewith, where the one or more capability parameters associated with the capability-based address may be used to control delivery of messages to the capability-based address. A user or entity requests a capability-based address from a communication service provider. The communication service provider provides a capability-based address to the user or entity. The user or entity provides the capability-based address to one or more other users or entities. The delivery of messages to the user or entity with which the capability-based address is associated is controlled based on the one or more capability parameters associated with the capability-based address of the user or entity.

### TECHNICAL FIELD

The disclosure relates generally to communication networks and, more specifically but not exclusively, to supporting delivery of messages in communication networks.

### BACKGROUND

Many situations arise in which a first user or entity is obligated or encouraged to provide their email address to a second user or entity (e.g., providing an email address in conjunction with registration with a web service provider, providing an email address in conjunction with a web-based transaction, or the like). The second user or entity may then use the email address in an unrestricted manner, and may even give or sell the email address to one or more additional users or entities who can further use or share the email address. The dispersion of the email address in this manner often leads to the receipt of unwanted email by the first user or entity.

### SUMMARY OF EMBODIMENTS

Various deficiencies in the prior art may be addressed by embodiments for supporting capability-based communications.

In one embodiment, an apparatus includes a processor and a memory communicatively connected to the processor, where the processor is configured to process a message comprising a capability-based address, the capability-based address having associated therewith a capability parameter for use in controlling delivery of a message directed to the capability-based address.

In one embodiment, a computer-readable storage medium stores instructions which, when processed by a computer, cause the computer to perform a method that includes processing a message comprising a capability-based address, the capability-based address having associated therewith a capability parameter for use in controlling delivery of a message directed to the capability-based address.

In one embodiment, a method includes using a processor for processing a message comprising a capability-based address, the capability-based address having associated therewith a capability parameter for use in controlling delivery of a message directed to the capability-based address.

### BRIEF DESCRIPTION OF THE DRAWINGS

The teachings herein can be readily understood by considering the following detailed description in conjunction with the accompanying drawings, in which:

FIG. 1 depicts an exemplary communication system configured to generate and use a capability-based email address;

FIG. 2 depicts an exemplary method for generating and using a capability-based email address within the communication system of FIG. 1; and

FIG. 3 depicts a high-level block diagram of a computer suitable for use in performing functions described herein.

To facilitate understanding, identical reference numerals have been used, where possible, to designate identical elements that are common to the figures.

### DETAILED DESCRIPTION OF EMBODIMENTS

In general, a capability-based communication mechanism is provided for controlling delivery of messages to a user or entity. The capability-based communication mechanism may be configured for use in controlling delivery of electronic mail (email) message, Simple Message Service (SMS) messages, Instant Messages (IMs), social media messages, or the like; however, the capability-based communication mechanism is primarily depicted and described herein within the context a capability-based email mechanism configured to control delivery of email messages to a user or entity.

In at least some embodiments, a capability-based email mechanism is provided for controlling delivery of email messages to a user or entity. The capability-based email mechanism uses a capability-based email address (CBEA), which is assigned to a user or an entity, to control delivery of email messages to the user or entity. In general, a CBEA is an email address having one or more email capabilities (ECs), which also may be referred to herein as EC parameters or capability parameters, associated therewith. The one or more ECs associated with the CBEA may be used to control delivery of email messages to the CBEA. For example, use of a CBEA to control delivery of email messages may include determining whether delivery of an email message(s) is authorized (e.g., based on one or more of a number of uses permitted for the CBEA, an expiration date of the CBEA, a permitted sender(s) for the CBEA, or the like), controlling the manner in which delivery of an email message(s) is performed (e.g., delivered on a particular day, at a particular time of day, in a particular format, or the like), or the like, as well as various combinations thereof. The one or more ECs associated with the CBEA also may be used to control one or more activities related to delivery of email messages to the CBEA (e.g., determining whether to notify a sender of the email regarding success or failure of delivery of the email message, controlling a manner in which a sender of an email message is notified regarding success or failure of delivery of the email message, or the like, as well as various combinations thereof). The CBEA may be used at one or more locations along a path from a potential sender of an email message to an intended recipient of an email message (e.g., by a potential sender of an email message to determine whether or not to send the email message, by a network device on a path between a sender of the email message and the email service provider which issued the CBEA, by the email service provider which issued the CBEA, or the like, as well as various combinations thereof). Various embodiments of the capability-based email mechanism, including embodiments related to generation and use of a CBEA, may be better understood by considering an exemplary communication system configured for generation and use of a CBEA.

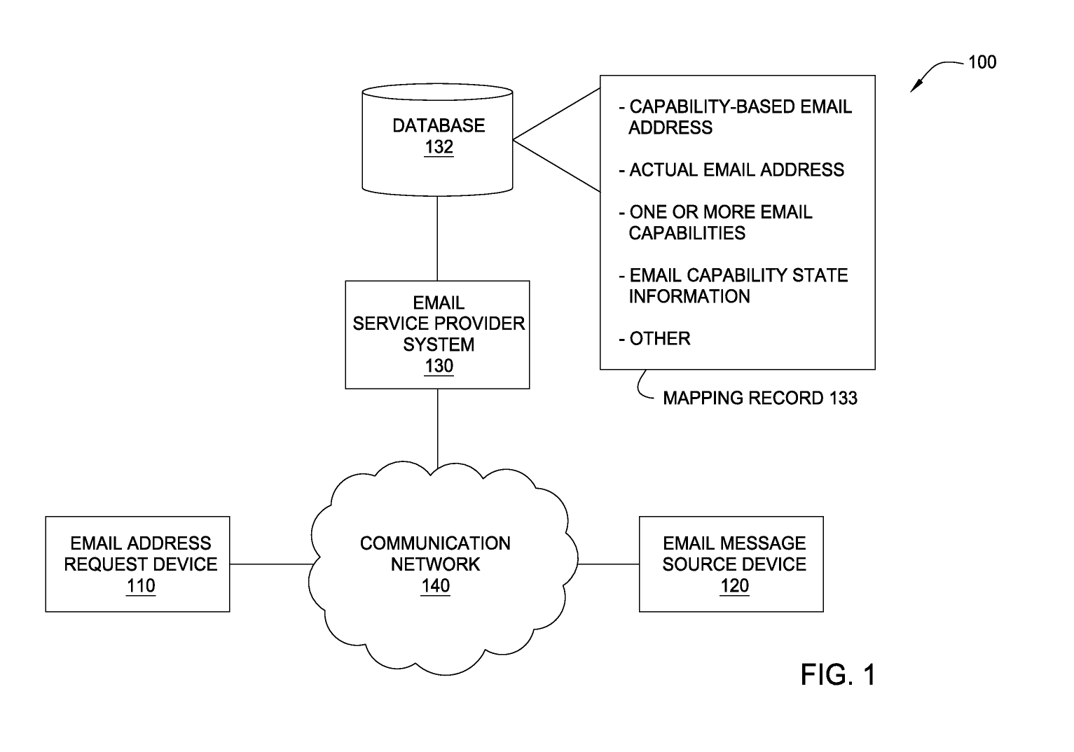

FIG. 1 depicts an exemplary communication system configured to generate and use a CBEA.

The exemplary communication system 100 includes an email address request device (EARD) 110, an email message source device (EMSD) 120, an email service provider system (ESPS) 130, and a communication network (CN) 140.

The EARD 110 may be configured to send a request for a CBEA. For example, where the CBEA is associated with a user, the EARD 110 may be a user device (e.g., a desktop computer, laptop computer, tablet computer, smart phone, or the like) via which a user may initiate a request for a CBEA or a device configured to initiate a request for a CBEA on behalf of the user. For example, where the CBEA is associated with an entity (e.g., corporation, organization, educational institution, governmental organization, or the like), the EARD 110 may be a user device via which a user may initiate a request for a CBEA on behalf of the entity or a device (e.g., server or the like) configured to send a request for a CBEA on behalf of the entity. Thus, the EARD 110 may be any device suitable for use in manually or automatically initiating a request for a CBEA.

The EMSD 120 may be configured to send an email message. For example, the EMSD 120 may be a user device (e.g., a desktop computer, laptop computer, tablet computer, smart phone, or the like) via which a user may initiate an email message directed to the CBEA or a network device (e.g., server or the like) configured to send an email message directed to the CBEA. Thus, the EMSD 120 may be any device suitable for use in manually or automatically sending an email message directed to the CBEA.

The ESPS 130 may be operated by an email service provider. Although omitted for purposes of clarity, the ESPS 130 may include one or more servers configured to handle email messages for users or entities having email accounts managed by the email service provider. For example, the servers may receive emails initiated by users or entities having email accounts with the email service provider, and may propagate the email messages toward the intended recipients. Similarly, for example, the servers may receive and store email messages intended for users or entities having email accounts managed by the email service provider, such that the email messages may be routed toward the intended recipients or stored for later access by the intended recipients when logging into the email accounts. The ESPS may be configured to perform various other functions typically supported by email service providers. The ESPS 130 may be configured to manage various aspects of the capability-based email mechanism.

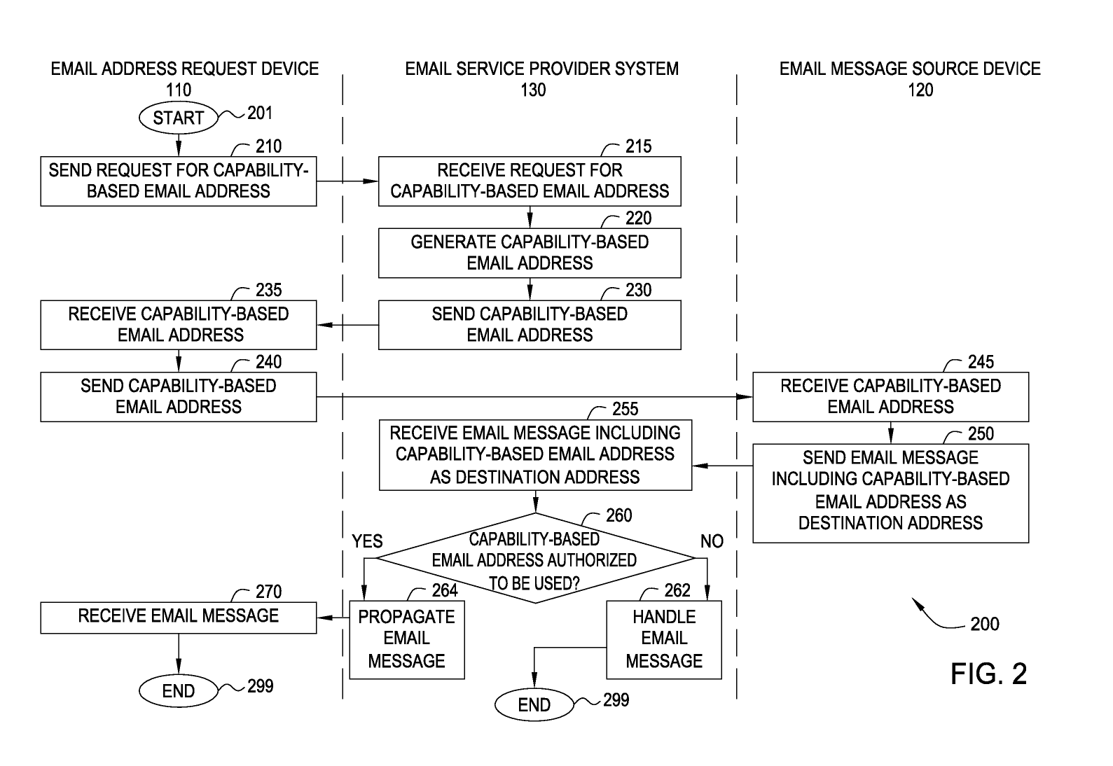

The ESPS 130 may be configured to generate a CBEA (e.g., receive a request for a CBEA from EARD 110, generate a CBEA based on the request for the CBEA, and provide the CBEA to the EARD 110). The generation of a CBEA may be better understood by way of reference to FIG. 2.

The ESPS 130 may be configured to control delivery of email messages directed to the CBEA (e.g., receiving an email message including the CBEA as a destination address, determining based on one or more ECs associated with the CBEA whether use of the CBEA is authorized, and handling the email message appropriately based on the determination as to whether use of the CBEA is authorized). The processing of email messages directed to the CBEA may be better understood by way of reference to FIG. 2.

The ESPS 130 may be configured to maintain information associated with the CBEA, including information associated with generation of the CBEA and, optionally, information associated with use of the CBEA. For example, the ESPS 130 may include a database 132 configured to maintain, for a given CBEA generated for a user or entity, a mapping record including information associated with the CBEA generated for the user or entity. For example, a mapping record of the database 132 may include a mapping of the actual email address for the user or entity and the CBEA generated for the user or entity. For example, a mapping record of the database 132 also may include information indicative of one or more ECs associated with CBEA (although such information also or alternatively may be recovered from the CBEA itself as explained later herein), e.g., for use in determining whether delivery of email message is authorized, for use in controlling delivery of email messages authorized to be delivered, or the like. For example, a mapping record of the database 132 also may include EC state information associated with one or more ECs associated with the CBEA (e.g., tracking the number of times the CBEA has been used, tracking an indication as to whether or not a user or entity attempting to use the CBEA has made a payment required for use of the CBEA, or the like) where the one or more ECs associated with the CBEA may be dependent upon tracking of such EC state information for evaluation as to whether use of the CBEA is authorized. In general, a mapping record of the database 132 may include any other suitable information which may be maintained by the email service provider for the CBEA. An exemplary mapping record 133 for the CBEA generated for EARD 110 is depicted in FIG. 1.

The ESPS 130 may be configured to support various other functions related to generation or use of the CBEA.

The CN 140 may be configured to support communication between EARD 110, EMSD 120, and ESPS 130. For example, CN 140 may include a data-based CN (e.g., a public data network such as the Internet, a private data network, or the like, as well as various combinations thereof). It will be appreciated that, although not specifically depicted, email messages directed to the EARD traverse the ESPS 130 for processing before being forwarded to the EARD 110.

The operation of exemplary communication system 100 in generating and using a CBEA may be better understood by first considering various characteristics of a CBEA.

In at least some embodiments, a CBEA is an email address having one or more ECs associated therewith.

The one or more ECs associated with a CBEA may be used to control delivery of email messages to the CBEA.

The use of one or more ECs to control delivery of email messages may include determining whether delivery of an email message(s) to the CBEA is authorized (e.g., based on one or more of a number of permitted uses for the CBEA, an expiration date of the CBEA, a permitted sender(s) for the CBEA, or the like). For example, ECs which may be used to determine whether delivery of an email message to the CBEA is authorized may include one or more of a number of times that the CBEA may be used (e.g., for the life of the CBEA, per month, per year, or the like, as well as various combinations thereof), an expiration date of the CBEA, a maximum size of email messages which may be sent to the CBEA (e.g., in megabytes, kilobytes, or the like), a list of approved senders authorized to use the CBEA, text which must be included within an email message directed to the CBEA (e.g., text within the subject line of the email message, text within the body of the email, or the like), a price which must be paid in order for an email message to be directed to the CBEA, a number of times that email messages may be sent to the CBEA for free and after which a price must be paid in order for an email message to be directed to the CBEA, or the like, as well as various combinations thereof.

The use of one or more ECs to control delivery of email messages may include controlling the manner in which delivery of an email message(s) is performed (e.g., delivered based on temporal considerations, delivered in a particular format, or the like). For example, ECs which may be used to determine whether delivery of an email message to the CBEA is authorized may include one or more of a time of day at which email messages directed to the CBEA are to be delivered to the user or entity associated with the CBEA, a day of the week or month on which email messages directed to the CBEA are to be delivered to the user or entity associated with the CBEA, an indicator that is indicative of a format in which email messages directed to the CBEA are to be delivered to the user or entity associated with the CBEA, an indicator that email messages are to be batched together in digest form prior to delivery to the user or entity associated with the CBEA, or the like, as well as various combinations thereof.

The one or more ECs associated with a CBEA may be used to control one or more activities related to delivery of email messages to the CBEA (e.g., determining whether to notify a sender of the email regarding success or failure of delivery of the email message, controlling a manner in which a sender of an email message is notified regarding success or failure of delivery of the email message, or the like, as well as various combinations thereof). For example, ECs which may be used to control one or more activities related to delivery of email messages to the CBEA may include one or more of an indicator as to whether to notify a sender of an email message that delivery of the email message was successful, an indicator as to whether to notify a sender of an email message that delivery of the email message was unsuccessful, or the like, as well as various combinations thereof. In at least some embodiments, a CBEA, similar to an actual email address, includes a local portion and a domain portion separate by the “@” symbol, which may be expressed as follows: <local portion>@<domain portion>. An example of such an email address is example@emailserviceprovider.com. As with actual email addresses, a CBEA may be globally unique and, further, the local portion of the CBEA may be unique within the domain specified by the domain portion (e.g., unique within the domain of the email service provider of the CBEA).

In at least some embodiments, a CBEA includes a unique tag. The unique tag may be the local portion of the CBEA or may be included within the local portion of the CBEA. The unique tag may be used to ensure uniqueness of the CBEA. The unique tag may be configured to include (e.g., via encoding) or point to (e.g., where the unique tag is a key into one or more tables) information associated with the CBEA (e.g., the one or more ECs associated with the CBEA, one or more actual email addresses associated with the CBEA, or the like, as well as various combinations thereof).

The one or more ECs associated with a CBEA may be associated with the CBEA in any suitable manner.

In at least some embodiments, one or more ECs may be associated with the CBEA by encoding the one or more ECs within the CBEA.

In at least some embodiments, the one or more ECs may be encoded within the CBEA by encoding the one or more ECs in combination with the unique tag of the CBEA. An example of such a CBEA is wx9zr5b@emailserviceprovider.com, where “wx9zr5b” is a value which may be decoded to recover the unique tag of the CBEA and information indicative of the one or more ECs associated with the CBEA.

In at least some embodiments, the one or more ECs may be encoded within the CBEA by encoding the one or more ECs using one or more encoded tags in addition to the unique tag of the CBEA. An example of such a CBEA is wx9zr5b_hj7ds84_dk8dlsq@emailserviceprovider.com, where “wx9zr5b” is the unique tag of the CBEA, “hj7ds84” is an encoded representation of a first EC associated with the CBEA (and the first EC may be determined by decoding this value), and “dk8dlsq” is an encoded representation of a second EC associated with the CBEA (and the second EC may be determined by decoding this value).

It will be appreciated that a combination of such techniques may be used to encode the one or more ECs within the CBEA.

In at least some embodiments, one or more ECs may be associated with the CBEA using one or more tables. In at least some embodiments, the unique tag of the CBEA may be used as a key into a table(s) storing the one or more ECs of the CBEA. An example of such a CBEA is wx9zr5b@emailserviceprovider.com, where “wx9zr5b” is the unique tag of the CBEA, which may be used as a key into a table storing information indicative of the one or more ECs associated with the CBEA. As noted herein, in at least some embodiments the table also may maintain other information related to the CBEA (e.g., an association of the CBEA to one or more actual email addresses or the like). An example of such a table entry is the entry 133 depicted within the database 132 of FIG. 1.

In at least some embodiments, the CBEA, in addition to the unique tag and, optionally, one or more encoded tags representing one or more ECs, also may include information identifying one or more of the ECs associated with the CBEA in a format that is capable of being understood directly from the CBEA (e.g., without requiring decoding, access to additional tables, or the like). The inclusion of such information enables a user(s) or device(s) that has access to the CBEA to perform one or more functions (even where the user(s) or device(s) may not have access to encoded information specifying the ECs of the CBEA.

In at least some embodiments, when a CBEA includes information identifying one or more ECs adapted for use in determining whether delivery of an email message based on the CBEA is authorized, the information may be used by a user or device that has access to the CBEA to determine whether or not delivery of an email message based on the CBEA is authorized. For example, a determination as to whether delivery of an email message to the CBEA is authorized, based on one or more ECs directly indicated within the CBEA, may be performed by the EMSD 120 before the email message is generated by the EMSD 120 and sent from the EMSD 120 toward the EARD 110, thereby conserving various resources (e.g., resources that would otherwise have been used by the EMSD 120 to generate the email message, network resources needed to transport the email message from the EMSD 120 to the ESPS 130, resources that would otherwise have been used by the ESPS 130 to perform the determination as to whether use of the CBEA is authorized, or the like). For example, a determination as to whether delivery of an email message to the CBEA is authorized, based on one or more ECs directly indicated within the CBEA, may be performed by a network device disposed on a path from the EMSD 120 to the ESPS 130, thereby conserving various resources (e.g., a portion of the network resources needed to transport the email message from the EMSD 120 to the ESPS 130, resources that would otherwise have been used by the ESPS 130 to perform the determination as to whether use of the CBEA is authorized, or the like). The determination as to whether delivery of an email message to the CBEA is authorized, based on one or more ECs directly indicated within the CBEA, may be performed by any other suitable device or at any other suitable location.

For example, where the CBEA has associated therewith an EC indicating that the CBEA may only be used three times (e.g., for the life of the CBEA, per month, or the like), a device may determine this threshold of the number of uses of the CBEA via parsing of the CBEA and, thus, may determine whether or not to forward or send an email message using the CBEA based on a comparison of the threshold of the number of uses of the CBEA to an actual number of uses of the CBEA available to the device. A first example of such a CBEA is wx9zr5b_w=3@emailserviceprovider.com, where the parameter “w=3” indicates that the CBEA may only be used three times for the life of the CBEA. A second example of such a CBEA is wx9zr5b_m=2@emailserviceprovider.com, where the parameter “m=2” indicates that the CBEA may only be used twice per month. The actual number of uses of the CBEA may be maintained by the device as state information (e.g., updated by the device each time the CBEA is used), retrieved by the device from a remote source of such information (e.g., from the ESPS 130 when the device making the comparison is EMSD 120, from a device associated with EMSD 120 when the device making the comparison is EMSD 120, or the like), or the like. It will be appreciated that, when the actual number of uses of the CBEA is obtained from a source other than the ESPS 130, the actual number of uses may not reflect the total actual number of uses of the CBEA as tracked by the ESPS 130 and, thus, the email message may or may not be delivered to the CBEA depending on a determination by the ESPS 130 as to whether the threshold has been satisfied (e.g., the threshold may already have been satisfied where one or more other users or entities also have used the CBEA to send one or more email messages and this information is not available to the device that is performing the comparison).

For example, where the CBEA has associated therewith an EC indicating an expiration date of Jun. 30, 2012, a device may determine this expiration date via parsing of the CBEA and, thus, may determine whether or not to send an email message using the CBEA based on the expiration date. An example of such a CBEA is

wx9zr5b_e=6.1.2012@emailserviceprovider.com, where the parameter “e=6.1.2012” indicates that the CBEA expires on Jun. 1, 2012 and may not be used after that date.

For example, where the CBEA has associated therewith an EC indicating a maximum size of 25 kilobytes for email messages sent to the CBEA, a device may determine this maximum email size via parsing of the CBEA and, thus, may determine whether or not to send an email message using the CBEA based on the maximum email size. An example of such a CBEA is wx9zr5b_s=25@emailserviceprovider.com, where the parameter “s=25” indicates that an email message directed to the CBEA must be smaller than 25 kilobytes or the email message will not be delivered.

For example, where the CBEA has associated therewith an EC indicating a single approved sender having an email address of user@emailsender.com, a device may determine the approved sender via parsing of the CBEA and, thus, may determine whether or not to send an email message using the CBEA based on the approved sender. An example of such a CBEA is

wx9zr5b_s=user_emailsender_com@emailserviceprovider.com, where the parameter “s=user_emailsender_com” indicates that the CBEA is only authorized to be sent from an email account using the email address of user@emailsender.

For example, where the CBEA has associated therewith an EC indicating required text that must be included within an email message directed to the CBEA, a device may determine the required text via parsing of the CBEA and, thus, may determine whether or not to send an email message using the CBEA based on the required text. A first example of such a CBEA where the text must be included in the subject line of the email message is wx9zr5b_h=<STORE_NAME>@emailserviceprovider.com, where the parameter “h=<STORE_NAME>” indicates that an email message directed to the CBEA must include the indicated store name in the subject line of the email message. A second example of such a CBEA where the text must be included in the body of the email message is wx9zr5b_b=<SITE_WORD>@emailserviceprovider.com, where the parameter “b=sale” indicates that an email message directed to the CBEA must include the word “sale” in the body of the email message.

For example, where the CBEA has associated therewith an EC indicating that a price of $1.00 must be paid in order to use the CBEA, device may determine this price of use via parsing of the CBEA and, thus, may determine whether or not to send an email message using the CBEA based on the price of use. An example of such a CBEA is wx9zr5b_p=$1.00@emailserviceprovider.com, where the parameter “p=$1.00” indicates that the CBEA may only be sent after the sender pays or agrees to pay $1.00 to the user or entity associated with the CBEA.

For example, where the CBEA has associated therewith an EC indicating that five email messages may be sent to the CBEA for free after which a price of $1.00 must be paid in order to use the CBEA, a device may determine this pricing arrangement via parsing of the CBEA and, thus, may determine whether or not to send an email message using the CBEA based on the pricing arrangement. An example of such a CBEA is wx9zr5b_f=5_p=$1.00@emailserviceprovider.com, where a combination of the parameters “f=5” and “p=$1.00” indicates that five email messages may be sent to the CBEA for free after which the sender must pay or agree to pay $1.00 to the user or entity associated with the CBEA in order to send an email message to the CBEA. It will be appreciated that, when such information is used to determine whether or not to send an email message to the CBEA, a determination that the number of free uses of the CBEA not been satisfied may only indicate that the number of free uses of the CBEA has not been satisfied by the particular user or entity for which the determination is made and, thus, that the sender may ultimately have to pay the $1.00 fee in order for the email message to be delivered to the CBEA depending on a determination by the ESPS 130 as to whether the number of free uses of the CBEA not been satisfied (e.g., the number of free uses of the CBEA may already have been satisfied where one or more other users or entities also sent one or more email messages to the CBEA).

It will be appreciated that, although primarily depicted and described with respect to use of specific parameters and parameter formats to represent the information identifying one or more ECs adapted for use in determining whether delivery of an email message based on the CBEA is authorized, the information identifying one or more ECs adapted for use in determining whether delivery of an email message based on the CBEA is authorized may be represented using any other suitable parameters or associated parameter formats.

In at least some embodiments, when a CBEA includes information identifying one or more ECs adapted for use in controlling delivery of an email message to the CBEA, the information may be used by a device that has access to the CBEA to determine the manner in which the email message is delivered to the CBEA. It will be appreciated that any suitable parameter(s) and associated parameter format(s) may be used to represent information identifying one or more ECs adapted for use in controlling delivery of an email message to the CBEA.

In at least some embodiments, when a CBEA includes information identifying one or more ECs adapted for use in performing one or more actions related to delivery of an email message to the CBEA, the information may be used by a device that has access to the CBEA to perform one or more actions related to delivery of an email message to the CBEA. It will be appreciated that any suitable parameter(s) and associated parameter format(s) may be used to represent information identifying one or more ECs adapted for use in performing one or more actions related to delivery of an email message to the CBEA.

It will be appreciated that combinations of ECs may be indicated within the CBEA, in a format that is capable of being understood directly from the

CBEA, where the CBEA has multiple ECs associated therewith. A first example of a CBEA including indications of multiple ECs is wx9zr5b_w=100_m=4@emailserviceprovider.com, where the parameters “w=100” and “m=4” indicate that no more than one hundred email messages may be sent to the CBEA at a rate not exceeding four email messages per month. A second example of a CBEA including indications of multiple ECs is wx9zr5b_h=STORE1_s=10@emailserviceprovider.com, where the parameters “h=STORE1” and “s=10” indicate that only email messages having the text STORE1 in the subject line and smaller than ten kilobytes may be delivered to the CBEA. A third example of a CBEA including indications of multiple ECs is wx9zr5b_w=10_f=5_p=0.50@emailserviceprovider.com, where the parameters “w=10”, “f=5”, and “p=0.50” indicate that no more than ten email messages may be sent to the CBEA where the first five email messages are free and the second five email messages require payment of a price of fifty cents per email message. The manner in which other combinations of ECs may be expressed within a CBEA will be understood from the foregoing examples.

In at least some embodiments, the CBEA may include one or more other types of information which may be associated with the CBEA. In one embodiment, for example, the CBEA may include information indicative of one or more actual email addresses associated with the CBEA (e.g., encoded in combination with the unique tag of the CBEA to provide a single value which may be decoded to recover the unique tag and the one or more actual email addresses, encoded as one or more additional values which may be included as part of the CBEA in addition to the unique tag and (optionally) the one or more ECs), or the like, as well as various combinations thereof). It will be appreciated that other types of information which may be associated with the CBEA also may be included within the CBEA.

The operation of exemplary communication system 100 in generating and using a CBEA may be better understood by way of reference to FIG. 2.

It will be appreciated that, although primarily depicted and described with respect to an embodiment in which the user or entity with the CBEA has only a single device associated therewith (namely, EARD 110), the user or entity with the CBEA may have any suitable number of devices associated therewith where one or more such devices may be used to request CBEA, access email messages sent to the CBEA, or the like.

It will be appreciated that, although primarily depicted and described with respect to an embodiment in which the ESPS 130 supports a single EARD 110 and a single EMSD 120, the ESPS 130 may be configured to support many EARDs 110 used to request CBEAs and many EMSDs 120 configured to direct email messages to EARDs using CBEAs.

It will be appreciated that, although primarily depicted and described with respect to an embodiment in which the communication system 100 includes a single ESPS 130, the communication system 100 may include any suitable number of ESPSs 130 configured to support generation and use of CBEAs.

FIG. 2 depicts an exemplary method for generating and using a CBEA within the communication system of FIG. 1. As depicted in FIG. 2, various steps of the method 200 are performed by the EARD 110, the EMSD 120, and the ESPS 130, respectively. At step 201, method 200 begins.

At step 210, EARD 110 sends a request for a CBEA to the ESPS 130.

At step 215, the ESPS 130 receives the request for the CBEA from the EARD 110. The request for the CBEA has associated therewith one or more ECs to be associated with the CBEA that is generated in response to the request for the CBEA. For example, the one or more ECs may be provided from the EARD 110 in conjunction with the request for the CBEA (e.g., included within a message including the request, provided within a separate message sent in conjunction with the request, or the like). For example, the one or more ECs may have been previously configured by a user or an entity associated with the EARD 110 and then accessed by the ESPS 130 based on the request for the CBEA (e.g., stored by the ESPS 130 and retrieved locally based on an actual email address or other identifier associated with the EARD 110, stored by a device other than the ESPS 130 and retrieved by the ESPS 130 based on an actual email address or other identifier associated with the EARD 110, or the like). It will be appreciated that, although primarily depicted and described with respect to an embodiment in which the one or more e-mail capabilities to be associated with the CBEA are specified by the user or entity for which the capability-based e-mail address is generated, in at least some embodiments the user or entity may only specify information adapted for use in determining the one or more ECs to be associated with the CBEA.

At step 220, the ESPS 130 generates the CBEA. The ESPS 130 generates the CBEA based on the request for the CBEA. The ESPS 130 generates the CBEA based on the one or more ECs associated with the request for the CBEA (or information adapted for use in determining the one or more ECs to be associated with the CBEA). The generation of the CBEA based on the one or more ECs associated with the request for the CBEA may include associating the one or more ECs with the CBEA, encoding at least a portion of the one or more ECs within the CBEA, or the like, as well as various combinations thereof. The generation of the CBEA based on information adapted for use in determining the one or more ECs to be associated with the CBEA may include determining the one or more ECs and then performing one or more of associating the one or more ECs with the CBEA, encoding at least a portion of the one or more ECs within the CBEA, or the like, as well as various combinations thereof.

At step 230, the ESPS 130 sends the CBEA to the EARD 110. At step 235, the EARD 110 receives the CBEA from the ESPS 130. The EARD 110 may then provide the CBEA, rather than the actual email address, to one or more third parties. This use of the CBEA is described with respect to steps 240-270 of method 200 of FIG. 2.

At step 240, the EARD 110 sends the CBEA to EMSD 120. At step 245, the EMSD 120 receives the CBEA from EARD 110. The CBEA may be used by a user or entity associated with EARD 110 in place of using the actual email address of the user or entity of EARD 110 (which does not need to be provided from the EARD 110 to the EMSD 120), thereby protecting the actual email address of the user or entity of EARD 110. The CBEA may be provided from the EARD 110 to the EMSD 120 in conjunction with any suitable type of activity (e.g., when a user associated with EARD 110 is ordering a product or service from an entity associated with the EMSD 120, when a user associated with EARD 110 joins a website operated by an entity associated with the EMSD 120, when a user associated with EARD 110 requests information from an entity associated with the EMSD 120, or the like). For example, the CBEA may be specified by the associated user or entity via entry of the CBEA in a field on a web page that is then submitted to the EMSD 120 or to a device that provides the capability-based e-mail address to the e-mail message source device 120, via inclusion of the CBEA within an e-mail message sent from the e-mail address request device 110 to the e-mail message source device 120, or the like. For example, the CBEA may be provided from the e-mail address request device 110 to the e-mail message source device 120 (or to a device that provides the capability-based e-mail address to the e-mail message source device 120) automatically via a communication channel. It will be appreciated that, although omitted for purposes of clarity, the CBEA may be made available to the EMSD 120 in any other suitable manner (e.g., where the user to which the CBEA is assigned provides the CBEA to the user of EMSD 120 in person and the user of EMSD 120 enters the CBEA into the EMSD 120, where the user to which the CBEA is assigned provides the CBEA to the user of EMSD 120 via a telephone call or text message and the user of EMSD 120 enters the CBEA into the EMSD 120, or the like).

At step 250, the EMSD 120 sends an email message that includes the CBEA as a destination address. At step 255, the ESPS 130 receives the email message from the EMSD 120.

At step 260, the ESPS 130 determines whether the CBEA of the email message is authorized to be used and, thus, whether delivery of the email message to EARD 110 is authorized. The ESPS 130 determines whether the CBEA of the email message is authorized to be used based on the one or more ECs associated with the CBEA. The ESPS 130 determines whether the CBEA of the email message is authorized to be used by analyzing at least a portion of the one or more ECs associated with the CBEA. The ESPS 130 identifies the one or more ECs associated with the CBEA and analyzes at least a portion of the one or more ECs associated with the CBEA for determining whether the one or more one or more ECs associated with the CBEA are satisfied.

The ESPS 130 may identify the one or more ECs associated with the CBEA from the CBEA (e.g., where the one or more ECs is encoded within the CBEA), from a database using at least a portion of the CBEA as a key into the database (e.g., using the unique tag of the CBEA as a key, decrypting the unique tag and using at least a portion of the decrypted unique tag as a key, or the like), or the like.

The ESPS 130 determines whether the CBEA of the email message is authorized to be used by analyzing at least a portion of the one or more ECs associated with the CBEA. In the case of a single EC associated with the CBEA, the ESPS 130 determines whether the EC is satisfied. In the case of a multiple ECs associated with the CBEA, the ESPS 130 determines whether one or more of the multiple ECs is satisfied, depending on the type of logic specified for the multiple ECs associated with the CBEA (e.g., whether all ECs of the CBEA need to be satisfied, whether only a subset of the ECs of the CBEA need to be satisfied, or the like). As described herein, any suitable numbers and types of ECs may be associated with a CBEA in any suitable manner (e.g., using any suitable logic or complexity) and, therefore, analysis of the ECs of the CBEA may depend on the numbers and types of ECs associated with the CBEA, as well as the manner in which the ECs are defined for the CBEA.

The ESPS 130 may analyze an EC associated with the CBEA, for determining whether use of the CBEA is authorized, based on general information (e.g., information that does not change as the CBEA is used) or capability state information associated with the CBEA (e.g., information that changes as the CBEA is used). The type of information that is used may depend on the type of EC being analyzed. The manner in which ECs may be analyzed may be better understood by way of examples of specific ECs.

In at least some embodiments, in which the capability-based e-mail address has only one e-mail capability associated therewith, ESPS 130 determines whether the CBEA of the email message is authorized to be used by determining whether the EC is satisfied.

For example, where the CBEA has associated therewith an EC indicating that the CBEA may only be used a threshold number of times over the life of the CBEA, ESPS 130 determines whether use of the CBEA is authorized by determining this threshold number of uses, determining the number of times that the CBEA has been used, and determining whether use of the CBEA is authorized based on a determination as to whether or not the threshold number of uses has been satisfied. In this example, the analysis of the threshold number of uses is based on the number of times that the CBEA has been used within the specified time period, which is EC state information that is tracked by the email service provider for use in analyzing this EC of the CBEA.

For example, where the CBEA has associated therewith an EC indicating an expiration date for the CBEA, ESPS 130 determines whether use of the CBEA is authorized by determining this expiration date, determining a date associated with the email message (e.g., date sent, date received by ESPS 130, or the like), and determining whether use of the CBEA is authorized based on a determination as to whether or not the CBEA has expired.

For example, where the CBEA has associated therewith an EC indicating a maximum size for email messages sent to the CBEA, ESPS 130 determines whether use of the CBEA is authorized by determining this maximum email size, determining the size of the email message, and determining whether use of the CBEA is authorized based on a determination as to whether or not the maximum email size has been exceeded.

For example, where the CBEA has associated therewith an EC indicating a single approved sender for the CBEA, ESPS 130 determines whether use of the CBEA is authorized by determining the approved sender, determining the sending email address of the email message, and determining whether use of the CBEA is authorized based on a determination as to whether or not the approved sender sent the email message.

For example, where the CBEA has associated therewith an EC indicating required text that must be included within the subject line of the email message, ESPS 130 determines whether use of the CBEA is authorized by determining the required text that must be included within the subject line, determining the subject line of the email message, and determining whether use of the CBEA is authorized based on a determination as to whether or not the subject line of the email message includes the required text.

For example, where the CBEA has associated therewith an EC indicating that a specific price must be paid in order to use the CBEA, ESPS 130 determines whether use of the CBEA is authorized by determining the required price, determining whether the required price has been paid, and determining whether use of the CBEA is authorized based on a determination as to whether or not the required price has been paid.

In at least some embodiments, in which the capability-based e-mail address has multiple e-mail capabilities associated therewith, ESPS 130 determines whether the CBEA of the email message is authorized to be used by determining whether one or more of the ECs is satisfied. In at least some embodiments, multiple ECs of a CBEA may be defined such that all of the multiple ECs need to be satisfied in order for use of the CBEA to be authorized. In at least some embodiments, multiple ECs of a CBEA may be defined such that only a subset of the multiple ECs needs to be satisfied in order for use of the CBEA to be authorized. Examples of various types of logic which may be used in order to define multiple ECs for a CBEA follow.

In at least some embodiments, as described above, the ECs of the CBEA may be defined such that all of the ECs must be satisfied in order for use of the CBEA to be authorized (e.g., a logical AND operation). For example, two ECs may be defined such that both of the ECs must be satisfied in order for use of the CBEA to be authorized.

In at least some embodiments, the ECs of the CBEA may be defined such that only one of the ECs must be satisfied in order for use of the CBEA to be authorized (e.g., a logical OR operation). For example, three ECs may be defined such that if any one of the three ECs is satisfied then use of the CBEA is determined to be authorized.

In at least some embodiments, the ECs of the CBEA may be defined using combinations of such logical operations. For example, three sets of ECs, each including two ECs, may be defined such that use of the CBEA is determined to be authorized as long as both of the ECs of any of the sets of ECs are determined to be satisfied.

Accordingly, it will be appreciated that any suitable numbers and types of ECs may be associated with a CBEA in any suitable manner (e.g., using any suitable logical associations between ECs). For example, a CBEA may have a threshold number of uses capability and an approved senders capability associated therewith, defined such that the CBEA may be used by anyone until the threshold number of uses is satisfied, after which the CBEA may only be used by the approved sender(s). For example, a CBEA may have an expiration date capability and a price of use capability associated therewith, defined such that use of the CBEA is free up until the expiration date, after which a fee must be paid in order for the CBEA to be used. For example, a CBEA may have an expiration date capability, an approved senders capability, and a price of use capability associated therewith, defined such that use of the CBEA is free for any sender(s) on the approved senders list use of the CBEA requires payment of the price of use for any sender(s) not on the approved senders list, but that all use of the capability-based e-mail address after the expiration date is prohibited. It will be appreciated that the foregoing examples are merely a few of the various ways in which combinations of ECs may be defined for and associated with a CBEA.

Accordingly, it will be appreciated that only a portion of the one or more ECs associated with the CBEA may need to be analyzed in order to determine whether use of the CBEA is authorized, because, when one of the ECs associated with the CBEA is determined not to be satisfied, the CBEA may be identified as not being authorized to be used such that there is no need to evaluate any remaining ECs not yet analyzed. Similarly, it will be appreciated that only a portion of the one or more ECs associated with the CBEA may need to be analyzed in order to determine whether use of the CBEA is authorized, because, when one of the ECs associated with the CBEA is determined to be satisfied, the CBEA may be identified as being authorized to be used such that there is no need to evaluate any remaining ECs not yet analyzed.

As depicted and described with respect to FIG. 1, the EC state information associated with the CBEA may be maintained by the email service provider in conjunction with information associated with the CBEA.

If a determination is made that the CBEA is not authorized to be used, method 200 proceeds to step 262, at which point the ESPS 130 handles the email message based on the determination that the CBEA is not authorized to be used (e.g., dropping the email message rather than forwarding the email message toward the EARD 110, sending a notification to the EMSD 120 to inform the user or entity that the email message could not be delivered because the CBEA is no longer authorized to be used, or the like, as well as various combinations thereof).

If a determination is made that the CBEA is authorized to be used, method 200 proceeds to step 264, at which point the ESPS 130 handles the email message based on the determination that the CBEA is authorized to be used (e.g., associates the email message with an email account of the user or entity such that the user or entity may access the email message when the user or entity accesses the email account, propagates the email message toward the EARD 110, or the like). In method 200 of FIG. 2, step 264 depicts an embodiment in which the email message is propagated to the EARD 110 (e.g., which may be in response to a determination that delivery of the email message is authorized, at a later time in response to a user accessing an email account with which the email message is associated when a determination is made that delivery of the email message is authorized, or the like).

In at least some embodiments, the handling of the email message may be based on one or more ECs associated with the CBEA.

In one or more embodiments in which a determination is made that the CBEA is authorized to be used, one or more of the ECs associated with the CBEA may be used to control the manner in which delivery of the email message is performed (e.g., delivered based on temporal considerations, delivered in a particular format, or the like). For example, an EC associated with the CBEA may indicate one or more temporal requirements for delivery of the email message (e.g., a day of the week on which the email message is to be delivered, a time of day at which the email address is to be delivered, or the like, as well as various combinations thereof). For example, an EC associated with the CBEA may indicate a format in which the email message is to be delivered. For example, an EC associated with the CBEA may indicate that the email message is to be batched together with one or more other email messages (independent of or based on any suitable characteristic(s) of the email messages) in digest form prior to delivery. It will be appreciated that other types of ECs may be used to control delivery of email messages. It also will be appreciated that various combinations of ECs may be used to control delivery of the email messages.

In one or more embodiments in which a determination is made that the CBEA is authorized to be used or is not authorized to be used, one or more of the ECs associated with the CBEA may be used to control one or more activities related to delivery of the email message. For example, an EC associated with the CBEA may indicate whether a sender of the email message is to be notified when delivery of the email message is successful. For example, an EC associated with the CBEA may indicate whether a sender of the email message is to be notified when delivery of the email message fails. It will be appreciated that other types of ECs may be used to control one or more activities related to delivery of email messages. It also will be appreciated that various combinations of ECs may be used to control one or more activities related to delivery of email messages.

At step 270, the EARD 110 receives the email message from the ESPS 130.

At step 299, method 200 ends.

In at least some embodiments, as described herein, various functions of method 200 may be performed by devices other than those depicted and described with respect to FIG. 2. This may be enabled by including one or more of the ECs within the CBEA in a format that is capable of being determined directly from parsing of the CBEA, providing one or more devices other than ESPS 130 access to one or more of the ECs of the CBEA when the one or more ECs are not capable of being determined directly from parsing of the CBEA (e.g., providing the one or more devices with the encoding/decoding information which may be used to decode portions of the CBEA in order to recover the one or more ECs, providing the one or more devices with access to all or part of a mapping record associated with the CBEA, or the like, as well as various combinations thereof), or the like. This enables various functions of method 200 to be performed by devices other than those depicted and described with respect to FIG. 2 (e.g., enabling the EMSD 120 to determine whether use of the CBEA is authorized, enabling a device disposed between the EMSD 120 and the ESPS 130 to determine whether use of the CBEA is authorized, enabling a device other than ESPS 130 to control one or more activities related to delivery of the email message, or the like, as well as various combinations thereof.

In at least some embodiments, for example, a determination as to whether use of the CBEA is authorized may be performed by the EMSD 120 before the email message is sent from the EMSD 120 toward the EARD 110. The determination as to whether use of the CBEA is authorized may be performed when the CBEA includes information indicative of the one or more ECs associated with the CBEA such that the EMSD 120 is able to check the status of each of the one or more ECs associated with the CBEA. If the EMSD 120 determines that use of the CBEA is no longer authorized, the source email device 120 will not generate the email message to the EARD 110, thereby conserving various resources (e.g., resources that would otherwise have been used by the EMSD 120 to generate the email message, network resources needed to transport the email message from the EMSD 120 to the ESPS 130, resources that would otherwise have been used by the ESPS 130 to perform the determination as to whether use of the CBEA is authorized, or the like). If the EMSD 120 determines that use of the CBEA is authorized, the source email device 120 will generate the email message to the EARD 110 and propagate the email message toward the EARD 110 (and the determination as to whether use of the CBEA is authorized may be performed again by ESPS 130).

In at least some embodiments, for example, a determination as to whether use of the CBEA is authorized may be performed by a network device that is disposed on a communication path between the EMSD 120 and the ESPS 130. The determination as to whether use of the CBEA is authorized may be performed when the CBEA includes information indicative of the one or more ECs associated with the CBEA such that the EMSD 120 is able to check the status of each of the one or more ECs associated with the CBEA. If the network device determines that use of the CBEA is no longer authorized, the network device may drop the email message, thereby conserving various resources (e.g., network resources needed to transport the email message the remainder of the way from the network device to the ESPS 130, resources that would otherwise have been used by the ESPS 130 to perform the determination as to whether use of the CBEA is authorized, or the like). If the network device determines that use of the CBEA is authorized, the network device will forward the email message toward the EARD 110 (and the determination as to whether use of the CBEA is authorized may be performed again by ESPS 130).

It will be appreciated, at least from FIG. 1 and FIG. 2, that various devices may be configured to process messages including CBEAs. For example, the EARD 110 may be configured to process a message including a CBEA in that the EARD 110 may receive a response message including the CBEA generated by the ESPS 130, store the CBEA, generate a reporting message including the CBEA, and propagate the reporting message including the CBEA toward the EMSD 120. For example, the EMSD 120 may be configured to process a message including a CBEA in that the EARD 110 may receive a reporting message including the CBEA from EARD 110, store the CBEA received in the reporting message, determine whether to generate an email message using the CBEA as a destination address, generate an email message using the CBEA as a destination address, and propagate the email message toward the EARD 110. For example, the ESPS 130 may be configured to process a message including a CBEA in that the ESPS 130 may receive an email message including the CBEA from the EMSD 120, determine whether delivery of the email message including the CBEA is authorized, and handle the email message according to the determination as to whether delivery of the email message including the CBEA is authorized. In at least some embodiments, the processing of a message including a CBEA may be considered to include any other suitable functions which may be performed for any suitable type of message including a CBEA, which may include messages reporting generation of the CBEA, messages providing the CBEA, email messages in which the CBEA is a destination address, or the like.

It will be appreciated that, although primarily depicted and described herein with respect to embodiments in which the EARD 110 is also the device used to access email messages directed to the CBEA, in at least some embodiments one or more other devices may be used to access email messages directed to the CBEA (e.g., where the user or entity requests a CBEA via a desktop computer but checks associated email messages via a mobile device, where the user or entity requests a CBEA via a mobile device but checks associated email messages via a laptop computer, or the like).

It will be appreciated that, although primarily depicted and described herein within the context of a capability-based communication mechanism for use with email messages, various embodiments depicted and described herein may be adapted for use with various other types of messages. For example, various embodiments of the capability-based email mechanism that are depicted and described herein may be adapted for use in controlling delivery of Simple Message Service (SMS) messages, Instant Messages (IMs), social media messages, or the like. For example, a capability-based telephone number having one or more capability parameters associated therewith may be used to control one or more aspects of delivery of text messages to the phone associated with the capability-based telephone number. For example, a capability-based telephone number having one or more capability parameters associated therewith may be used to control whether voice calls may be made or SMS messages may be delivered using the capability-based telephone number. For example, the structure(s) of one or more address types (e.g., SMS addresses, IM addresses, or the like) may be adapted for use in supporting embodiments of the capability-based communication mechanism. Thus, various references herein to email-based terms (e.g., email messages, capability-based email addresses, and the like) may be read using other terms specific to other types of communications (e.g., using SMS-based terms for SMS-based communications, using IM-based terms for IM-based communications, or the like) or may be read more generally using terms intended to cover multiple types of communications (e.g., using more general terms such as messages, capability-based addresses, or the like)

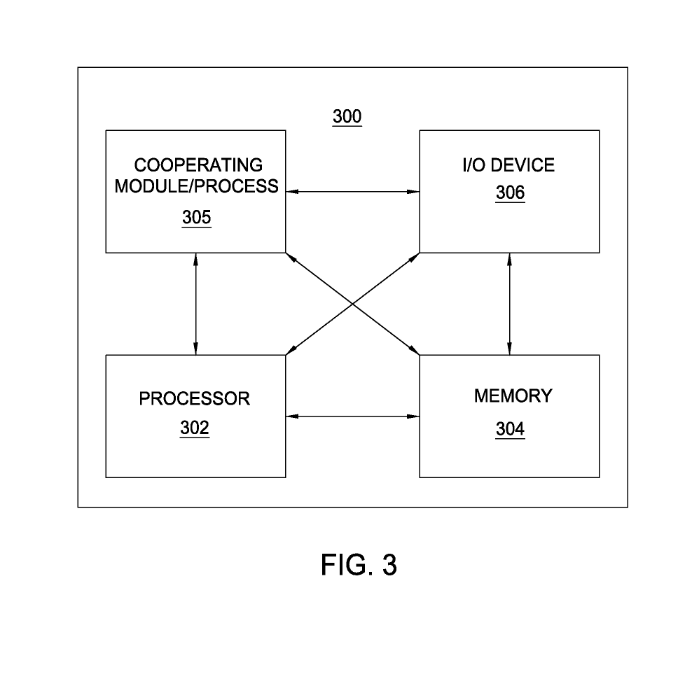

FIG. 3 depicts a high-level block diagram of a computer suitable for use in performing functions described herein.

The computer 300 includes a processor 302 (e.g., a central processing unit (CPU) or other suitable processor(s)) and a memory 304 (e.g., random access memory (RAM), read only memory (ROM), and the like).

The computer 300 also may include a cooperating module/process 305. The cooperating process 305 can be loaded into memory 304 and executed by the processor 302 to implement functions as discussed herein and, thus, cooperating process 305 (including associated data structures) can be stored on a computer readable storage medium, e.g., RAM memory, magnetic or optical drive or diskette, and the like.

The computer 300 also may include one or more input/output devices 306 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 300 depicted in FIG. 3 provides a general architecture and functionality suitable for implementing functional elements described herein or portions of functional elements described herein. For example, the computer 300 provides a general architecture and functionality suitable for implementing one or more of EARD 110, a portion of EARD 110, EMSD 120, a portion of EMSD 120, ESPS 130, a portion of ESPS 130, one or more elements of CN 140, or the like.

It will be appreciated that the functions depicted and described herein may be implemented in hardware or a combination of software and hardware, e.g., using a general purpose computer, via execution of software on a general purpose computer so as to provide a special purpose computer, using one or more application specific integrated circuits (ASICs) or any other hardware equivalents, or the like, as well as various combinations thereof.

It will be appreciated that at least some of the method steps discussed herein may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods or techniques described herein are invoked or otherwise provided. Instructions for invoking the inventive methods may be stored in fixed or removable media, transmitted via a data stream in a broadcast or other signal bearing medium, or stored within a memory within a computing device operating according to the instructions.

It will be appreciated that the term “or” as used herein refers to a non-exclusive “or,” unless otherwise indicated (e.g., “or else” or “or in the alternative”).

It will be appreciated that, while the foregoing is directed to various embodiments of features present herein, other and further embodiments may be devised without departing from the basic scope thereof.

what is claimed is:

1. An apparatus, comprising:
a processor and a memory communicatively connected to the processor, the processor configured to:
process a message comprising a capability-based address, the capability-based address having associated therewith a capability parameter for use in controlling delivery of a message directed to the capability-based address.

2. The apparatus of claim 1, wherein the capability parameter comprises a parameter for use in determining whether delivery of a message directed to the capability-based address is authorized.

3. The apparatus of claim 2, wherein the capability parameter comprises at least one of:
a parameter indicative of a threshold number of times the capability-based address may be used within a length of time;
a parameter indicative of a date or time at which the capability-based address expires;
a parameter indicative of a maximum permitted size of a message directed to the capability-based address;
a parameter indicative of at least one approved sender authorized to send a message directed to the capability-based address;
a parameter indicative of text to be included in a message directed to the capability-based address; or
a parameter indicative of a price for delivery of a message directed to the capability-based address.

4. The apparatus of claim 1, wherein the capability parameter comprises a parameter for use in controlling a manner in which a message directed to the capability-based address is delivered.

5. The apparatus of claim 4, wherein the capability parameter comprises at least one of:
a parameter indicative of at least one temporal constraint for delivery of a message directed to the capability-based address; or
a parameter indicative of a format for delivery of a message directed to the capability-based address.

6. The apparatus of claim 1, wherein the processor is configured to:
receive a request to generate the capability-based address, the request to generate the capability-based address having associated therewith capability information for use in defining the capability parameter; and
generate the capability-based address based on the capability information associated with the request to generate the capability-based address.

7. The apparatus of claim 1, wherein the processor is configured to:
receive the message comprising the capability-based address; and
process the message comprising the capability-based address by extracting the capability-based address from the message and storing the capability-based address.

8. The apparatus of claim 1, wherein the message comprises an email message including the capability-based email address as a destination address, wherein the processor is configured to process the email message by determining, based on the capability parameter, whether delivery of the email message is authorized.

9. The apparatus of claim 8, wherein the processor is configured to determine whether delivery of the email message is authorized by:
determining capability parameter comparison information associated with the capability parameter; and
determining whether delivery of the email message is authorized based on a comparison of the capability parameter and the capability parameter comparison information associated with the capability parameter.

10. The apparatus of claim 8, wherein the processor is configured to:
based on a determination that delivery of the email message is not authorized, prevent delivery of the email message.

11. The apparatus of claim 8, wherein the processor is configured to:
based on a determination that delivery of the email message is not authorized, drop the email message.

12. The apparatus of claim 8, wherein the processor is configured to:
based on a determination that delivery of the email message is authorized, initiate delivery of the email message. 20

13. The apparatus of claim 8, wherein the processor is configured to:
based on a determination that delivery of the email message is authorized:
determine an actual email address associated with the capability-based address; and
propagate the email message based on the actual email address.

14. The apparatus of claim 1, wherein the message comprises an email message including the capability-based email address as a destination address, wherein the processor is configured to process the email message by determining, based on the capability parameter, a manner in which the email message is to be delivered.

15. The apparatus of claim 14, wherein the processor is configured to:
initiate delivery of the email message based on the determined manner in which the email message is to be delivered.

16. The apparatus of claim 1, wherein the capability-based parameter is encoded within a portion of the capability-based address or maintained within a table entry associated with the capability-based address.

17. The apparatus of claim 1, wherein the processor is configured to:
determine the capability parameter based on at least a portion of the capability-based address.

18. The apparatus of claim 17, wherein the processor is configured to determine the capability parameter based on at least a portion of the capability-based address by:
decoding a portion of the capability-based address to recover the capability parameter;
accessing a table storing the capability parameter using at least a portion of the capability-based address as a key into the table; or
parsing at least a portion of the capability-based address to identity the capability parameter.

19. A computer-readable storage medium storing instructions which, when executed by a computer, cause the computer to perform a method, the method comprising:
processing a message comprising a capability-based address, the capability-based address having associated therewith a capability parameter for use in controlling delivery of a message directed to the capability-based address.

20. A method, comprising:
using a processor for:
processing a message comprising a capability-based address, the capability-based address having associated therewith a capability parameter for use in controlling delivery of a message directed to the capability-based address.
